(19) United States
(12) Patent Application Publication
(10) Pub. No.: US 2026/0034584 A1
(43) Pub. Date: Feb. 5, 2026

(54) SYSTEM AND METHOD FOR SELECTIVE LASER SINTERING BY MEANS OF A SYSTEM

(71) Applicant: Ford Global Technologies, LLC, Dearborn, MI (US)

(72) Inventors: Bruno Alves, Huerth (DE); Heiko Homrighausen, Aachen (DE)

(73) Assignee: Ford Global Technologies, LLC, Dearborn, MI (US)

(21) Appl. No.: 19/284,087

(22) Filed: Jul. 29, 2025

(30) Foreign Application Priority Data
Jul. 31, 2024 (DE) 102024121847.9

(51) Int. Cl. B22F 10/36; B22F 10/28; B33Y 10/00; B33Y 30/00; B33Y 50/02

(52) U.S. Cl. CPC B22F 10/36; B22F 10/28; B33Y 10/00; B33Y 30/00; B33Y 50/02

(57) ABSTRACT

A system and a method for selective laser sintering by a system that has a selective laser sintering device and at least one regulating device. The regulating device is coupled to the selective laser sintering device and to an analysis device integrated into the system. The analysis device may analyze a proportion of a powder material, which is used in the selective laser sintering, during a sintering process. The regulating device may adjust the sintering process based on the analyzed powder material.

### CROSS-REFERENCE TO RELATED APPLICATION

This application claims priority to and the benefit of German Patent Application No. 102024121847.9, filed on Jul. 31, 2024. The disclosure of the above application is incorporated herein by reference.

### FIELD

The disclosure relates generally to a system and to a method for selective laser sintering by means of a system.

### BACKGROUND

The statements in this section merely provide background information related to the present disclosure and may not constitute prior art.

Additive manufacturing technologies are widely used at present in order to produce prototypes or constituent parts in small numbers, for example vehicle parts and other constituent parts. In this way, the development work can be made more efficient.

One known additive manufacturing technology that is employed in this context relates to powder bed fusion methods (PBF methods), in which a powder bed is generated. The powder of the powder bed is then selectively melted or fused in order to produce desired component structures. By way of example, selective laser sintering (SLS) may be used for this, which in combination with the PBF method also makes overhangs possible, in contrast to other manufacturing methods. After a first layer of melted or fused powder material, the processing plane is lowered and the powder bed is replenished by a distribution device. Subsequently, the next layer of the component to be manufactured is generated. This step is repeated until the component to be manufactured is finished. At least a proportion of excess powder is subsequently reused for a next sintering process.

For the performance of the manufacturing process and the properties of the manufactured constituent part, the properties of the powder material used is of high importance. In general, however, the sintering process and the thermal conditions of the sintering process influence the properties of the powder. In principle, there is nothing in this context to inhibit the repeated use and recycling of powder from leading to a deterioration of the material, so that it has modified material properties and, in particular, its thermal properties and flow properties change. The powder consequently has varying properties, which may also influence the manufacturing process, for example the properties of the component to be manufactured. By way of example, degraded powder may lead to a lower density, inferior mechanical properties and increased porosity of the manufactured components.

US 2023/0062971 A1 discloses a system for the monitoring, analysis and adjustment of an additive manufacturing process. The system has an analysis processor, which is separate from an additive manufacturing device. The analysis processor comprises a hybrid model, which combines the physics of the additive process and a data analysis model in order to identify an inconsistency in production and/or in the additive manufacturing device and to adjust a configuration of the additive manufacturing device during production. The inconsistencies relate, for example, to unintended functionalities of the constituent parts of the manufacturing apparatus and/or to unintended component structures.

EP 3 659 727 A1 relates to an additive manufacturing method in which a radiation signature of electromagnetic radiation is examined in order to distinguish a sufficient or insufficient melting procedure at an intended melting location.

CN 114216911 A relates to an additive manufacturing method in which the powder bed is monitored during the selective laser melting of metals. On the basis of comparing a powder bed image existing at a given instant with a starting powder bed image, corrective measures may be implemented in respect of the powder laying procedure.

In this way, however, previous approaches do not relate to an analysis of the actual powder material used in the manufacturing procedure, but only relate to other parameters or the powder bed that is generated, for which reason inconsistencies of the manufacturing process that are due to variations of the powder material have hitherto not been identifiable, or have been identifiable only insufficiently. In particular, it has not hitherto been possible to detect variations that are caused by varying powder properties within an individual sintering process.

### SUMMARY

This section provides a general summary of the disclosure and is not a comprehensive disclosure of its full scope or all of its features.

The present disclosure provides a system to detect and at least partially compensate for variations of the sintering process that are caused by variations of the powder material.

According to one aspect, some examples of the disclosure relate to a system having a selective laser sintering device (referred to below as an SLS device). The system has at least one regulating device, which is coupled to the SLS device and to an analysis device integrated into the system. The analysis device is configured to analyze a proportion of a powder material, which is used in the SLS, during a sintering process. The regulating device is configured to adjust the sintering process on the basis of the analyzed powder material.

The disclosure is based on the finding that an SLS device may be combined with an analysis device within a system in order to carry out an analysis of the powder material during the sintering process and subsequently to correspondingly adjust the sintering process adaptively. In this way, variations of the properties of the powder material may be detected within an individual sintering process, which comprises a plurality of sintering procedures. Detecting the variation of the properties of the powder material makes it possible to adjust the sintering process in such a way as to be able to compensate for the divergences, caused by the varying properties of the powder material, between successive sintering procedures of the sintering process. In this way, it is possible here to inhibit a sintering process from first having to be concluded fully and the powder only then being analyzed in the scope of reuse. Rather, adjustments may take place within an individual sintering process. In order to provide this, a sample of the powder material used may be taken and analyzed, for example for each partial process of the sintering process, i.e. for example each time a replenished powder bed is provided for successive sintering procedures. In this way, a sintering process having a consistent high standard is provided so that the properties of the manufactured component are likewise homogeneous and, in particular, can correspond to the parameters established in advance.

Consequently, the standard of the production process and of the manufactured components is increased in comparison to previous approaches. For example, it also makes it possible to reduce the rejection of inconsistent constituent parts. In this way, the environmental compatibility of the present system is higher in comparison to previous approaches.

According to a further aspect, some examples of the disclosure relate to a method for SLS by means of a system. The system has at least one regulating device, which is coupled to the SLS device and to an analysis device integrated into the system. The method comprises at least the following steps:
a proportion of a powder material, which is used in the SLS, is analyzed by the analysis device during a sintering process, and
the sintering process is adjusted by the regulating device on the basis of the analyzed powder material.

The advantages that are achieved by the system described herein are also achieved in a corresponding way by the method.

The SLS device may have conventional constituent parts of such a device, in particular a laser, a scanner, for example a galvanometer scanner, a component platform, a climate control device and a processing space that is sealed from an external space.

Typically, the scanner and the component platform are arranged inside the processing space.

Conventionally, the processing space has been thermally controlled. This means that at least one heating device and/or cooling device (in general a climate control device) may be coupled to the processing space in order to heat and/or cool the processing space according to a predetermined temperature profile. Typically, before the exposure of the powder bed to a laser beam which is generated by the laser, the processing space is heated to a temperature that lies below but close to the melting temperature of the powder material used in the scope of the sintering process. After the sintering procedures of the sintering process are concluded, the processing space, in which the finished component is then arranged in the powder bed, is cooled according to a predetermined temperature profile with the aid of a cooling procedure.

The scanner makes it possible to aim a laser beam, which is generated by the laser, at the component platform in order to melt and/or fuse specific powder amounts of the powder material used in the sintering process, so that predetermined three-dimensional manufacturing structures can be generated. The manufacturing structures are supported by the remaining powder of the powder bed, for which reason the manufactured components do not need to have supporting structures that are desired in other additive manufacturing methods. Typically, the scanner for aiming the laser beam has at least one or more mirrors which are mobile and thus allow aiming of the laser beam.

The overall sintering process is composed of a plurality of individual (successive) sintering procedures. The position of the powder bed and the position of the component platform typically remain constant during a sintering procedure. Between various sintering procedures of the sintering process, however, the component platform is displaced, usually vertically, so that the next layer of the component can be manufactured. Whereas the sintering process thus means the overall component manufacture, which for example also comprises a cooling procedure downstream of the sintering procedures, the sintering procedures mean individual partial processes of the exposure to the laser beam.

A powder distribution device, for example a blade or a roller, with which the powder bed can be replenished, is usually also arranged inside the processing space. A powder tank, from which new powder material can be conveyed onto the component platform for the processing during the sintering procedures, is also coupled to the processing space.

The powder platform is usually configured to be displaceable. In this way, the component platform can be displaced between successive processing steps of the sintering process, for example along a vertical direction, so that the constituent part to be manufactured is generated layer-by-layer by repeated exposure to the laser beam of the laser.

Optionally, a sampling device may be coupled to the powder distribution device, to the powder tank and/or to a delivery line. By means of the delivery line, the powder material is applied from the powder tank onto the component platform. By the sampling device, a proportion of the powder material may be taken in situ and in real time during the sintering process and delivered to the analysis device. In this way, the sintering process, or a sintering procedure thereof, may not be concluded, but instead a proportion of the powder material used may be taken and analyzed during the sintering process, or during individual sintering procedures or between successive sintering procedures. This ultimately allows in situ and real-time adjustment of the sintering process in relation to individual sintering procedures, in order to manage varying properties of the powder material.

In one example, the regulating device may be coupled to a plurality of constituent parts of the SLS device and/or of the analysis device, in order to be able to perform corresponding adjustments of the sintering process. For example, the regulating device may also be a regulating device of the SLS device itself, which generally monitors and controls all the sintering procedures. This regulating device may then be supplemented at least with an interface, for example a communication interface, with the aid of which the regulating device receives corresponding items of information from the analysis device in respect of the analysis of the powder material.

In some examples, the analysis device is configured to analyze the proportion of the powder material in respect of at least one thermal property. The thermal properties of the powder material used have a substantial influence on the additive manufacturing process in the scope of the sintering process. For example, parts of the powder material may be degraded so that they have a modified melting point in comparison to the pure powder material. For consistent properties of the component to be manufactured, it may then be desired to adjust the temperature in the processing space of the SLS device. By analyzing at least one thermal property of the powder material used, in this way it is possible to identify variations of the powder material used which have a substantial influence on the sintering process.

In one example, the analysis device is configured to analyze the proportion of the powder material on the basis of a dynamic differential calorimetry method. In dynamic differential calorimetry, a sample amount of the powder material used can be heated and/or cooled in a defined way. For example, a standardized crucible may be used for this purpose. Since a second standardized crucible is subjected to the same heating operation, but without a sample amount of the powder material, a phase transition of the powder amount, for example a melting temperature, may be identified highly precisely by comparing the resulting heat flow. This is made possible by the fact that the sample amount of the powder material, which is present in only one crucible, absorbs or releases additional thermal energy. The thermal properties of the sample amount of the powder material that are analyzed in this way may be compared with the thermal properties of undegraded powder material. This makes it possible to analyze in real time the powder material used in the sintering process, and to provide corresponding adjustments of the sintering procedures in order to take account of the varying properties of the powder material. A consistent standard of the manufactured component may thus be provided.

Optionally, the regulating device is configured to control the analysis device in such a way that the analysis device analyzes different proportions of the powder material during the sintering process according to a predetermined repetition rate. This provides that different proportions of the powder material used in the sintering process are analyzed, which allows continuous monitoring of the properties of the powder material and continuous adjustment of the sintering procedures. For example, sample amounts of the powder material used may be taken each time the powder bed is replenished and powder is for this purpose resupplied from the powder tank. Other repetition rates may of course also be provided. The regulating device may in particular specify the repetition rate of the analysis procedure that is carried out by the analysis device, and output a corresponding control signal to the analysis device. In order to take the sample amount, the delivery line may have, for example, a selective closable valve between the powder tank and the processing platform.

In one alternative, the repetition rate may also be specifiable by a user input by means of a user interface. In this way, the outlay that is caused by the analysis device may be controllable. For example, it is also possible in particular to influence the regulating period of the adjustment of the sintering process, which is defined by the repeated analyses.

In one example, a sample amount of the powder material may in particular constitute a fraction of the amount of powder material that is resupplied each time during the replenishing of the powder bed. For example, a weight of the sample amount may be 100 mg or less, in one example 50 mg or less, further in one example 20 mg or less, further in one example 10 mg or less, further in one example 5 mg or less, further in one example at least 1 mg.

In order to characterize the powder material, an initial amount of the powder material may be analyzed by the analysis device before the start of the sintering procedures of the sintering process. In order to characterize the powder material as precisely as possible, the initial amount may be significantly greater than the sample amount. For example, a weight of the initial amount may be 15000 mg or less, in one example 10000 mg or less, further in one example 7000 mg or less, further in one example 5000 mg or less, further in one example 500 mg or more, further in one example 100 mg or more, further in one example 2000 mg or more, further in one example substantially 3000 mg. In this way, good averaging is made possible in order to characterize the powder material in respect of its original properties before the sintering procedures. This characterization may be used later as a benchmark in the assessment of the sample amount.

In some examples, the regulating device is configured to vary at least one sintering parameter of a constituent part of the SLS device that is involved in a sintering procedure, and/or one cooling parameter of a cooling procedure downstream of the sintering procedures, on the basis of the analyzed powder material in such a way as to be able to compensate at least partially for variations of the sintering procedures and/or of the cooling procedure that are due to varying properties of the powder material. In this way, on the one hand the sintering procedures themselves, but on the other hand also the cooling procedure, may be adjusted in order to take account of the varying properties of the powder material. For the adjustment, the regulating device may be coupled to different constituent parts so that the variability in the adjustment in order to manage the properties of the powder material is high. In this way, homogenization of the sintering procedures in respect of the properties of the manufactured component is made possible so that the standard of the manufacturing process is high.

In one example, the regulating device is configured to adjust at least one of the following: a laser power of a laser, a scan speed of a laser beam that is guided over a processing surface and/or a temperature or a temperature profile of a processing space. If the melting temperature of the powder material rises with a continuing duration of the sintering process, for example, the laser power may be increased in order to be able to provide sufficient energy to a processing location in order to be able to melt and/or fuse the corresponding proportions of the powder material reliably. While the laser power of the laser relates to the generation of the laser beam itself, the scan speed may be varied with the aid of the movement speed of mirrors of the scanner, for example of a galvanometer scanner. In this way, parts of the powder material that have particular thermal properties may for example be exposed to the laser beam more slowly than this takes place for other parts of the powder material. Likewise, corresponding heating devices and/or cooling devices of the processing space may be controlled by the regulating device in order to provide an adjusted temperature profile and adjusted temperature parameters. If the powder material is analyzed by the analysis device as having an increased melting point, for example, the temperature of the processing space may be updated so that it has a constant difference with regard to the varying melting point of the analyzed powder amount. In this way, it is possible to provide that an additional energy deposition that is carried out by the laser beam can remain consistent in order to be able to melt and/or fuse the processed powder material.

In order to adjust the corresponding parameters of the sintering process and of the SLS device, the regulating device may output corresponding control signals to the respective constituent parts so that they adjust their operation parameters.

Optionally, the method is formed as a computer-implemented method. This means that the method steps can be carried out with the aid of one or more data-processing devices. In particular, a data-processing device of the regulating device may initiate or carry out the corresponding steps.

According to a further aspect, the disclosure also relates to a computer program product comprising instructions which, when the program is carried out by a computer, cause the latter to carry out the method as described herein. The advantages that are achieved by the method described herein are also achieved in a corresponding way by the computer program product.

According to an additional aspect, the disclosure also relates to a computer-readable storage medium comprising instructions which, when the program is carried out by a computer, cause the latter to carry out the method as described herein. The advantages that are achieved by the method described herein are also achieved in a corresponding way by the computer-readable storage medium.

All features explained in relation to the various aspects may be combined individually or in (sub) combination with other aspects.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a simplified schematic representation of a system according to one example of the present disclosure; and

FIG. 2 shows a simplified schematic representation of a method for selective laser sintering by means of a system according to one example of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The following detailed description in conjunction with the appended drawings, in which identical numerals refer to identical elements, is intended as a description of various examples of the disclosed subject matter and is not meant to represent the only examples. Each example described in this disclosure serves merely as an example or illustration and should not be interpreted as preferred or advantageous in relation to other examples. The illustrative examples contained herein make no claim to completeness and do not limit the claimed subject matter to the exact forms disclosed. Various modifications of the described examples are readily apparent to a person skilled in the art, and the general principles defined herein may be applied to other examples and applications without departing from the spirit and scope of the described examples. The described examples are therefore not limited to the examples shown, but have the widest possible range of application that is compatible with the principles and features disclosed here.

All features disclosed below with regard to the exemplary examples and/or the accompanying figures may be combined alone or in any sub-combination with features of the aspects of the disclosure, including features of examples, provided that the resultant combination of features is meaningful to a person skilled in the art.

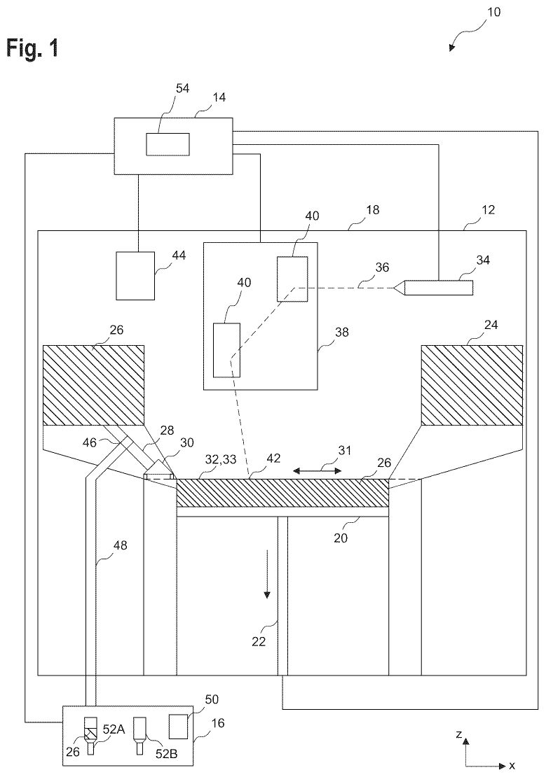

FIG. 1 shows a simplified schematic representation of a system 10 according to one example.

The system 10 comprises an SLS device 12, a regulating device 14 and an analysis device 16.

The SLS device 12 has a processing space 18 with a component platform 20. The component platform 20 is configured to be displaceable, here by means of a piston drive 22, along the vertical direction (z direction). According to this example, the piston drive 22 is configured to displace the component platform 20 at least according to a predetermined increment in the vertical direction. Typically, the increment is less than 1 mm, in one example less than 500 μm, further in one example less than 300 μm, further in one example 200 μm or less, and further in one example at least 10 μm.

The SLS device 12 also has a powder tank 24. A powder material 26 that is used for the processing inside the SLS device 12 in order to form the components to be manufactured is arranged in the powder tank 24. The powder material 26 is applied onto the component platform 20 via at least one delivery line 28. With the aid of a blade 30, which alternatively may also take the form of a roller, the powder material 26 is distributed uniformly on the component platform 20. The blade 30 in this case moves in the lateral direction, according to the arrow 31, over the horizontal xy plane. In this way, a powder bed 32 of the powder material 26 with a processing surface 33 is formed.

The SLS device 12 additionally has a laser 34, which according to this example is arranged inside the processing space 18. In alternative examples, the laser 34 may of course also be arranged outside the processing space 18.

The laser 34 generates a laser beam 36, which is directed onto a scanner 38. The scanner 38 according to this example is formed as a galvanometer scanner and has a plurality of mirrors 40.

With the aid of the mirrors 40, the laser beam 36 can be deflected in such a way that it is directed onto a processing location 42 on the processing surface 33 that is to be processed. By a modification of the alignment of the mirrors 40, the laser beam 36 can then selectively illuminate corresponding parts of the processing surface 33.

The SLS device 12 additionally has at least one climate control device 44 that acts on the processing space 18. The climate control device 44 is configured to heat or cool the processing space 18 according to a predetermined temperature, or to provide a temperature profile. In this way, the processing space 18 may for example be heated to a temperature below but close to the melting temperature of the powder material 26. With the aid of the exposure to the laser beam 36, the energy deposited by the laser beam 36 can now be sufficient to selectively melt or fuse the powder material 26 at the processing location 42, so that three-dimensional component structures can be formed in the powder bed 32.

After a sintering procedure corresponding to a partial process of the sintering process has taken place, the component platform 20 may be moved stepwise with the aid of the piston drive 22 for a next sintering procedure. Complex three-dimensional component structures with overhangs may thus be generated.

According to this example, the delivery line 28 has a branching connection, here in the form of a valve 46. With the aid of the valve 46, a sample amount of the powder material 26 being resupplied can be taken by means of the branch line 48 and delivered to the analysis device 16.

The analysis device 16 is in this case arranged separately from the processing space 18, although alternatively it may of course also be arranged inside the processing space 18.

The analysis device 16 of the system 10 has at least one climate control device 50. The analysis device 16 also has two crucibles 52A, 52B of the same kind. While the sample amount of the powder material 26 is received in the first crucible 52A, the second crucible 52B remains without a sample amount of the powder material 26.

The climate control device 50 of the analysis device 16 is configured to heat and/or cool the crucibles 52A, 52B in a defined way, so that the thermal properties of the crucibles 52A, 52B can be analyzed. Because the first crucible 52A additionally has the sample amount of the powder material 26, its thermal properties differ from the thermal properties of the second crucible 52B that is empty. Consequently, the sample amount of the powder material 26 can be characterized. For example, in this way a phase transition of the sample amount of the powder material 26, for example a melting point, may be ascertained.

The regulating device 14 has at least one data-processing device 54. The regulating device 14 is coupled at least to the SLS device 12 and to the analysis device 16. According to this example, the regulating device 14 is in particular also coupled to the laser 34, the scanner 38 and the climate control device 44 of the SLS device 12.

Based on the analysis of the sample amount of the powder material 26 by the analysis device 16, the regulating device 14 receives corresponding items of information from the analysis device 16, and it is configured to adjust the operating parameters of the laser 34, of the scanner 38 and of the climate control device 44 of the SLS device 12 so that it is possible to respond to the varying properties of the powder material 26 that are found by the analysis device 16. For example, the regulating device 14 is configured to adjust a laser power of the laser 34. Alternatively or in addition, the regulating device 14 is also configured to vary a scan speed of the laser beam 36 on the processing surface 33 with the aid of the controlling of the scanner 38. Furthermore, the regulating device 14 according to this example is also configured to adjust the temperature brought about by the climate control device 44 of the SLS device 12 inside the processing space 18.

In one example, the regulating device 14 is likewise configured to control the analysis device 16. For example, the regulating device 14 may predetermine a corresponding temperature profile that the analysis device 16 has to take into account by means of the climate control device 50 in the analysis of the sample amount of the powder material 26.

Furthermore, the regulating device 14 may also carry out controlling functions in respect of the valve 46, so that the taking of a sample amount of the powder material 26 is controlled by the regulating device 14. For instance, the regulating device 14 may also predetermine a repetition rate of the analysis of a corresponding sample amount of the powder material 26 by means of the valve 46 for the analysis device 16.

Although the regulating device 14 is represented here as a dedicated regulating device 14 of the system 10, the regulating device 14 may also be the usual regulating device of the SLS device 12, which has however been supplemented with the additional functions described here. In this case, the regulating device 14 may for example also undertake the controlling of the piston drive 22 of the component platform 20. In addition, the regulating device 14 may of course also control the resupplying with the powder material 26 from the powder tank 24, for example with the aid of valves (not represented here). Of course, the regulating device 14 may also carry out the function of the blade 30 for forming a homogeneous powder bed 32.

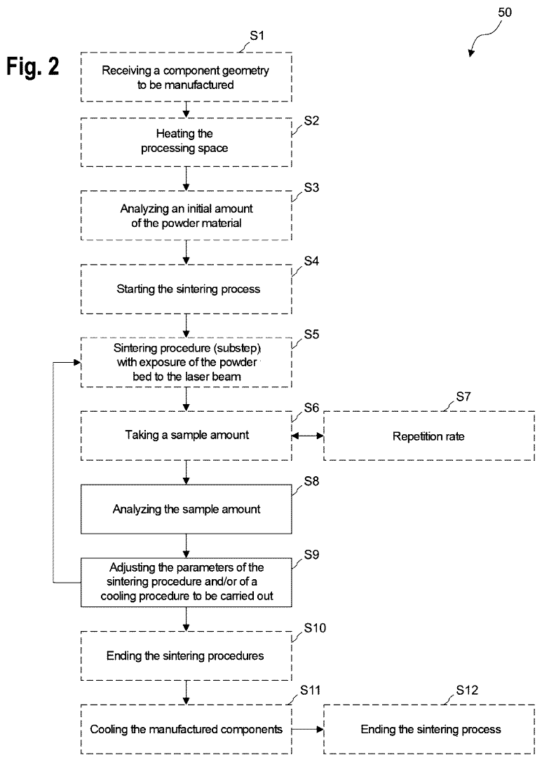

FIG. 2 shows a simplified schematic representation of a method 60 for selective laser sintering by means of a system 10 according to one example. Optional steps are represented by dashes.

In optional step S1 of the method 60, a component geometry to be manufactured of a component to be manufactured is received by the regulating device 14. For example, this may take place via a user interface of the system 10 or a communication interface.

In the subsequent optional step S2, the processing space 18 of the SLS device 12 is preheated. For this purpose, the regulating device 14 may for example output a corresponding control signal to the heating device 44 of the SLS device 12. The heating takes place to a temperature which is below but nevertheless close to the melting temperature of the powder material 26 provided. For example, a predetermined temperature difference between the melting point of the powder material 26 and the temperature of the processing space 18 may be maintained by a corresponding control signal of the regulating device 14. The temperature difference may, for example, be set by a user interface which is coupled to the regulating device 14.

The method 60 then comprises optional step S3, in which an initial amount of the powder material 26 to be used is analyzed with the aid of the analysis device 16. The initial amount may likewise be extracted with the aid of the valve 46 from the delivery line 28 for the analysis device 16. The initial amount is very much greater than the sample amount of the powder material 26 that is used later in the method 60, in order to provide a sufficient database for the characterization of the powder material 26 in respect of its thermal properties at the start of the sintering process. The analysis device 16 transmits the result of the analysis of the initial amount of the powder material 26 to the regulating device 14.

In the following optional step S4, the sintering process is started. The regulating device 14 in particular may carry out the controlling of the sintering process. For this purpose, the regulating device 14 may output corresponding control signals to all constituent parts involved, in particular the SLS device 12 and the analysis device 16, in particular to the laser 34, the scanner 38, the climate control device 44 of the SLS device 12, the piston drive 22 and the valve 46.

The sintering process comprises a plurality of individual sintering procedures. Between different sintering procedures, which represent partial procedures of the sintering process, the piston drive 22 is used to move the component platforms 20 so that a next layer of the powder bed 32 can be processed by the laser beam 36, in order to create a three-dimensional component structure.

Accordingly, the method 60 then comprises optional step S5, in which a first sintering procedure takes place, the powder bed 32 being exposed to the laser beam 36 according to the intended processing locations 42.

Once the sintering procedure of step S5 is concluded, the component platform 20 is moved by the piston drive 22. At this instant, powder material 26 is resupplied from the powder tank 24. In this context, optional step S6 takes place, in which a sample amount of the powder material 26 is taken, for example from the delivery line 28. The sample amount of the powder material 26 is delivered to the analysis device 16, and in particular to an individual crucible 52A thereof.

According to the following step S8, the sample amount of the powder material 26 that has been taken is analyzed by the analysis device 16 during the sintering process. For this purpose, the analysis device 16 may in particular use the climate control device 50 in order to ascertain the thermal properties of the sample amount of the powder material 26. Subsequently, the analysis device 16 transmits the corresponding measurement data or the thermal properties of the powder material 26, which have been ascertained from the measurement data, to the regulating device 14.

The method 60 then comprises step S9, in which the parameters of the sintering process are adjusted by the regulating device 14 on the basis of the result of the analysis of the sample amount of the powder material 26 by the analysis device 16.

For this purpose, the regulating device 14 may optionally compare the properties of the sample amount of the powder material 26, which were analyzed in step S8, with the corresponding analyzed properties of the initial amount of the powder material from optional step S3, in order to ascertain divergences that represent varying properties of the powder material 26. In one alternative, the comparison may also take place by the analysis device 16, which then only transmits the result of the comparison to the regulating device 14.

Since the sintering process comprises both the different sintering procedures and optionally a downstream cooling procedure, the parameters of the corresponding constituent parts, for example the constituent parts of the SLS device 12, may be adjusted both in relation to the following sintering procedures and in relation to the cooling procedure.

For example, the regulating device 14 may output corresponding control signals so that the laser power is adjusted by the laser 34. Alternatively or in addition, a control signal may be output so that the scan speed of the laser beam 36 on the processing surface 33 is adjusted with the aid of the scanner 38. In a further alternative or in addition, a control signal may be output to the climate control device 44 of the SLS device 12 so that the temperature and/or temperature profiles inside the processing space 18 are varied, in order to accommodate the varying properties of the powder material 26.

The method 60 then comprises an optional return to step S5, after which optional steps S5 and S6 as well as steps S8 and S9 are repeated.

The method 60 may be refined by optional step S7, in which the regulating device 14 sets a repetition rate for the taking of the sample amount of the powder material 26 and the analysis of this sample amount of the powder material 26 by the analysis device 16. The repetition rate may in this case be predefined or, for example, specified by a user input with the aid of a user interface. The regulating device 14 then adjusts the corresponding control signals so that the repetition rate is provided. For example, it is thus possible to provide that a sample amount of the powder material 26 is taken after each individual sintering procedure whenever powder material 26 is resupplied from the powder tank 24. The repeated sampling of the powder material 26 also provides that different amounts of the powder material 26 are analyzed. Continuous adaptive adjustment of the parameters of the sintering process is thus possible.

Following step S9, the method comprises optional step S10, in which the sintering procedures are ended. This means that the three-dimensional component structure to be generated is in principle completed. At this instant, however, it is still hot.

The method therefore comprises the following optional step S11, in which the manufactured components are cooled according to a predetermined cooling procedure. On the basis of the analyzed thermal properties of the sample amount of the powder material 26, the cooling procedure may be varied by the regulating device 14 in relation to an originally provided sequence of the cooling procedure, or it may have been varied in the scope of step S9. As an alternative to adjusting the temperature profile with the aid of the climate control device 44 of the SLS device 12 in the scope of step S9, the cooling procedure may of course also be varied only in the scope of optional step S11, in order to accommodate the varying properties of the powder material 26. In this regard, the method 60 is variable in respect of the precise instant of the adjustment of the temperature properties of the climate control device 44.

The method 60 ends with optional step S12, in which the entire sintering process, comprising all the sintering procedures and the optional cooling procedure, is ended.

A method 60 and a system 10 which make it possible to adjust the sintering process in situ and in real time in relation to varying properties of the powder material 26 used are thus provided. In this way, there is at least partial compensation for the effects of the varying properties of the powder material 26 on the component parts to be manufactured. Thus, the standard of the component parts to be manufactured may be made more consistent and more homogeneous over the entire manufactured component in comparison to previous approaches. The effect of this is that there are fewer rejects due to inconsistent manufactured components, because the components can be manufactured more precisely according to the originally desired properties. In this way, the efficiency of the manufacturing process is increased significantly in comparison to existing approaches.

Specific examples disclosed here use circuits (for example one or more circuits) in order to implement standards, protocols, methods or technologies disclosed here, to functionally couple two or more constituent parts, to generate items of information, to process items of information, to analyze items of information, to generate signals, to encode/decode signals, to convert signals, to transmit and/or receive signals, to control other items of equipment, etc. Circuits of any type may be used.

In one example, a circuit such as the regulating device comprises inter alia one or more data-processing devices such as a processor (for example a microprocessor), a central processing unit (CPU), a digital signal processor (DSP), an application-specific integrated circuit (ASIC), a field-programmable gate array (FPGA), a system on a chip (SoC) or similar, or any desired combinations thereof, and may comprise discrete digital or analog circuit elements or electronics, or combinations thereof. In one example, the circuit comprises hardware circuit implementations (for example implementations in analog circuits, implementations in digital circuits and the like, as well as combinations thereof).

In one example, circuits comprise combinations of circuits and computer program products with software or firmware instructions, which are stored on one or more computer-readable memories and interact in order to make an item of equipment carry out one or more of the protocols, methods or technologies described here. In one example, the circuit technology comprises circuits, for example microprocessors or parts of microprocessors, that utilize software, firmware and the like for operation. In one example, the circuits comprise one or more processors or parts thereof and the associated software, firmware, hardware and the like.

Amounts and numbers may be referred to in this disclosure. Unless otherwise expressly indicated, such amounts and numbers are not to be regarded as limiting, but as examples of the possible amounts or numbers in connection with the disclosure. In this context, the term “plurality” may also be used in the disclosure in order to refer to an amount or number. The term “plurality” in this context means any number that is greater than one, for example two, three, four, five, etc. The terms “about”, “approximately”, near” etc. mean plus or minus 5% of the value indicated.

Although the disclosure has been presented and described with regard to one or more examples, a person skilled in the art will be able to carry out equivalent changes and modifications after reading and understanding this description and the appended drawings.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system comprising:
a selective laser sintering device; and
at least one regulating device having a processor coupled to the selective laser sintering device and to an analysis device integrated into the system, the analysis device is configured to analyze a proportion of a powder material, which is used in the selective laser sintering device during a sintering process, and the at least one regulating device is configured to adjust the sintering process based on the analyzed powder material.

2. The system according to claim 1, wherein the analysis device is configured to analyze at least one thermal property of the proportion of the powder material.

3. The system according to claim 2, wherein the analysis device is configured to analyze the proportion of the powder material based on a dynamic differential calorimetry method.

4. The system according to claim 1, wherein the at least one regulating device is configured to control the analysis device to analyze different proportions of the powder material during the sintering process according to a predetermined repetition rate.

5. The system according to claim 1, wherein the at least one regulating device is configured to vary at least one of at least one sintering parameter of the selective laser sintering device in the sintering process, and one cooling parameter of a cooling procedure downstream of the sintering process based on the analyzed powder material to at least partially compensate for variations of at least one of the sintering process and of the cooling procedure that are due to varying properties of the powder material.

6. The system according to claim 5, wherein the at least one sintering parameter is at least one of a laser power of a laser, a scan speed of a laser beam that is guided over a processing surface, a temperature of a processing space and a temperature profile of a processing space.

7. The system according to claim 1, f wherein the analysis device includes a first crucible, a second crucible and at least one climate control device configured to at least one of heat and cool the first crucible and the second crucible, the first crucible configured to receive the proportion of the powder material and the second crucible is empty.

8. A method for selective laser sintering via a system including at least one regulating device having a processor, which is coupled to a selective laser sintering device and to an analysis device integrated into the system, the method comprising:
analyzing, via the analysis device during a sintering process, a proportion of a powder material used in the selective laser sintering device; and
adjusting, via the at least one regulating device, the sintering process based on the analyzed proportion of powder material.

9. The method according to claim 8, further comprising:
analyzing, via the analysis device, at least one thermal property of the proportion of the powder material.

10. The method according to claim 9, further comprising:
analyzing, via the analysis device, the proportion of the powder material based on a dynamic differential calorimetry method.

11. The method according to claim 8, further comprising:
controlling, by the at least one regulating device, the analysis device to analyze different proportions of the powder material during the sintering process according to a predetermined repetition rate.

12. The method according to claim 8, further comprising:
varying, by the at least one regulating device, at least one of at least one sintering parameter of the selective laser sintering device that is involved in the sintering process, and one cooling parameter of a cooling procedure downstream of the sintering process based on the analyzed powder material to at least partially compensate for variations of at least one of the sintering process and of the cooling procedure that are due to varying properties of the powder material.

13. The method according to claim 8, further comprising:
varying, by the at least one regulating device, at least one of a laser power of a laser, a scan speed of a laser beam that is guided over a processing surface, a temperature of a processing space and a temperature profile of a processing space to at least partially compensate for variations of the sintering process.

14. The method of claim 8, further comprising modulating, via a crucible, a temperature of the proportion of the powder material.

15. A system comprising:
an analysis device configured to analyze at least one thermal property of a proportion of a powder material used during a sintering process;
a selective laser sintering device configured to receive the powder material; and
at least one regulating device having a processor coupled to the selective laser sintering device and to the analysis device, the at least one regulating device configured to adjust the sintering process based on the at least one thermal property.

16. The system according to claim 15, wherein the analysis device is configured to analyze the proportion of the powder material based on a dynamic differential calorimetry method.

17. The system according to claim 15, wherein the at least one regulating device is configured to control the analysis device to analyze different proportions of the powder material during the sintering process according to a predetermined repetition rate.

18. The system according to claim 15, wherein the at least one regulating device is configured to vary at least one of at least one sintering parameter of the selective laser sintering device that is involved in the sintering process and one cooling parameter of a cooling procedure downstream of the sintering process based on the analyzed powder material to at least partially compensate for variations of at least one of the sintering process and of the cooling procedure that are due to varying properties of the powder material.

19. The system according to claim 18, wherein the at least one sintering parameter is at least one of a laser power of a laser, a scan speed of a laser beam that is guided over a processing surface, a temperature of a processing space and a temperature profile of a processing space.

20. The system according to claim 15, wherein the analysis device includes a first crucible, a second crucible and at least one climate control device configured to at least one of heat and cool the first crucible and the second crucible, the first crucible configured to receive the proportion of the powder material and the second crucible is empty.
